(19) United States
(12) Patent Application Publication
(10) Pub. No.: US 2009/0241188 A1
(43) Pub. Date: Sep. 24, 2009

(54) COMMUNICATION MONITORING APPARATUS AND COMMUNICATION MONITORING METHOD

(75) Inventor: Masahiro KOMURA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/408,717

(22) Filed: Mar. 22, 2009

(30) Foreign Application Priority Data
Mar. 21, 2008 (JP) 2008-074342

(51) Int. Cl. G06F 11/00

(52) U.S. Cl. 726/22

(57) ABSTRACT

A communication monitoring apparatus includes a session extracting unit which extracts a packet in a session established between a pair of a transmitting device and a receiving device from a plurality of packets, a lead-packet extracting unit which extracts a lead packet including control information on communication between the transmitting device and the receiving device from the packet, a storage unit in which an unauthorized signature is stored, a verification unit which performs verification between the lead packet and the unauthorized signature, and an output unit which supplies a monitoring result indicating that the session extracted by the session extracting unit is an unauthorized communication when the lead packet includes a portion matched with the unauthorized signature.

### CROSS-REFERENCE TO RELATED APPLICATIONS

This application is related to and claims priority to Japanese patent application no. 2008-74342 filed on Mar. 21, 2008 in the Japan Patent Office, and incorporated by reference herein.

### FIELD

The present invention relates to a communication monitoring apparatus and a communication monitoring method, particularly to a communication monitoring apparatus and a communication monitoring method which can reduce a processing load without deteriorating accuracy of detection of unauthorized communication.

### BACKGROUND

Conventionally, in communication between a server and a client through a network such as the Internet, it is important to prevent unauthorized communication where an unauthorized client having no authorized access right gets access to the server. For example, a firewall may be provided at a boundary between a LAN (Local Area Network) in an organization such as a company and an external network such as the Internet to restrict the communication between LAN and the outside.

Sometimes a protocol called HTTP (Hyper Text Transfer Protocol) is used in data transmission and reception between the server and the client through the Internet. HTTP is mainly used when the client obtains the data in a web page from a web server. Unless the data transmitted in the form of HTTP is individually set, the data is not interrupted by the firewall, and the data is freely transmitted and received between the server and the client. Accordingly, when a malicious user transmits control data in the form of HTTP to establish an unauthorized transmission path, a transmission path for the unauthorized communication may easily be established between the server and the client to conduct the unauthorized communication. The establishment of a transmission path for the unauthorized communication in which an uninterrupted protocol is utilized is usually called “tunneling”.

For example, the following technique can be used to prevent the tunneling. Because the control data used to establish the unauthorized transmission path includes a particular pattern during the tunneling, the data pattern is previously stored as a signature, and a determination whether or not the packet is utilized for the tunneling can be made by performing verification between an actually transmitted and received packet and the stored signature. In other words, when the transmitted and received packet includes the stored signature, it can be determined that the tunneling is performed.

However, in detecting the tunneling with the signature, it is necessary to perform the verification between the signature and all the packets transmitted and received between the server and the client, which causes a problem of an enormous processing load for monitoring the presence or absence of the unauthorized communication. That is, almost all the packets transmitted and received between the server and the client are used for the authorized communication, and an extremely small number of packets are used for the unauthorized communication such as the tunneling. However, the unauthorized communication can be detected only when all the packets are monitored. Accordingly, there is a limitation to the improvement of efficiency, because processing for performing the verification between the previously stored signature and the packet transmitted and received between the server and the client is repeated for all the packets.

The processing load can be reduced when some of the packets are randomly extracted as samples to perform the verification between the extracted packet and the signature. However, when the samples do not include a packet of the unauthorized communication, the accuracy of unauthorized communication detection may be deteriorated.

### SUMMARY

According to an aspect of the invention, a communication monitoring apparatus includes a session extracting unit for extracting a packet transmitted and received in a session established between a pair of a transmitting device and a receiving device from a plurality of packets transmitted and received by a specific protocol, a lead-packet extracting unit for extracting a lead packet including control information on communication between the transmitting device and the receiving device from the packet in the session extracted by the session extracting unit, a storage unit in which an unauthorized signature is stored, the unauthorized signature including a data pattern which distinctively appears in control information on unauthorized communication, a verification unit which performs verification between the lead packet extracted by the lead-packet extracting unit and the unauthorized signature stored in the storage unit, and an output unit which supplies a monitoring result indicating that the session extracted by the session extracting unit is the unauthorized communication when the lead packet includes a portion matched with the unauthorized signature as a result of the verification performed by the verification unit.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a block diagram schematically illustrating a configuration of a communication system according to an embodiment;

FIG. 2 illustrates a specific example of a message of the embodiment;

FIG. 3 illustrates a specific example of a packet configuration of the embodiment;

FIG. 4 is a sequence diagram illustrating a specific example of a communication procedure of the embodiment;

FIG. 5 is a block diagram illustrating a configuration of a main part of a communication monitoring apparatus of the embodiment;

FIG. 6 illustrates a specific example of an unauthorized signature of the embodiment;

FIG. 7 is a flowchart illustrating an operation of the communication monitoring apparatus of the embodiment;

FIG. 8 is a flowchart illustrating lead-packet extracting processing of the embodiment; and

FIG. 9 illustrates a specific example of the lead-packet extracting processing of the embodiment.

### DESCRIPTION OF EMBODIMENT

An aspect of an embodiment is to extract a lead packet including control data and to verify only the extracted lead packet for an unauthorized signature indicating a data pattern of unauthorized communication when a message made up of control data and information data is divided into a plurality of packets and transmitted.

An embodiment of the invention will be described in detail with reference to the drawings.

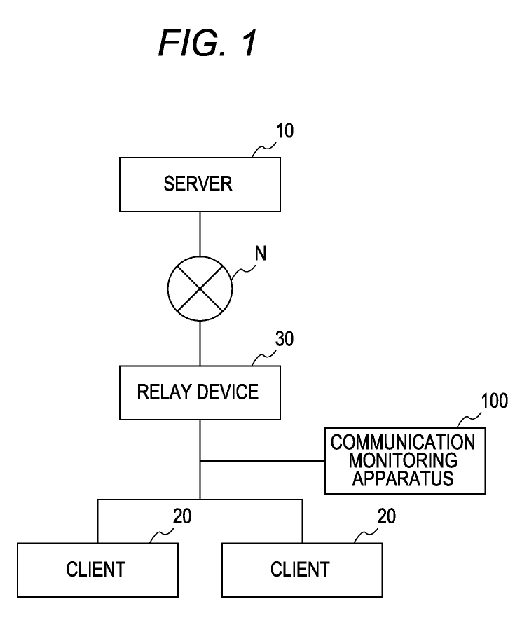

FIG. 1 is a block diagram schematically illustrating a configuration of a communication system according to an embodiment of the invention. Referring to FIG. 1, the communication system includes a server 10, a client 20, a relay device 30, and a communication monitoring apparatus 100.

The server 10 is connected to a network N, and the server 10 transmits and receives a packet to and from a plurality of clients 20 through the network N. The plurality of clients 20 are connected to the network N through the relay device 30 to transmit and receive the packet to and from the server 10. For example, the relay device 30 may include a router, a switch, or a firewall to relay the packet transmitted and received between the server 10 and the client 20.

The server 10 and the client 20 produce messages of application layers to make requests for data and give replies to each other. However, because the messages have various sizes, the messages are transmitted and received while formed into a packet having a specific size in a TCP/IP (Transmission Control Protocol/Internet Protocol) layer. That is, both the server 10 and the client 20 produce messages made up of control data having control information on the communication protocol and information data subject to the control information, and both the server 10 and the client 20 divide the produced message into a specific size corresponding to one packet and then transmit the message.

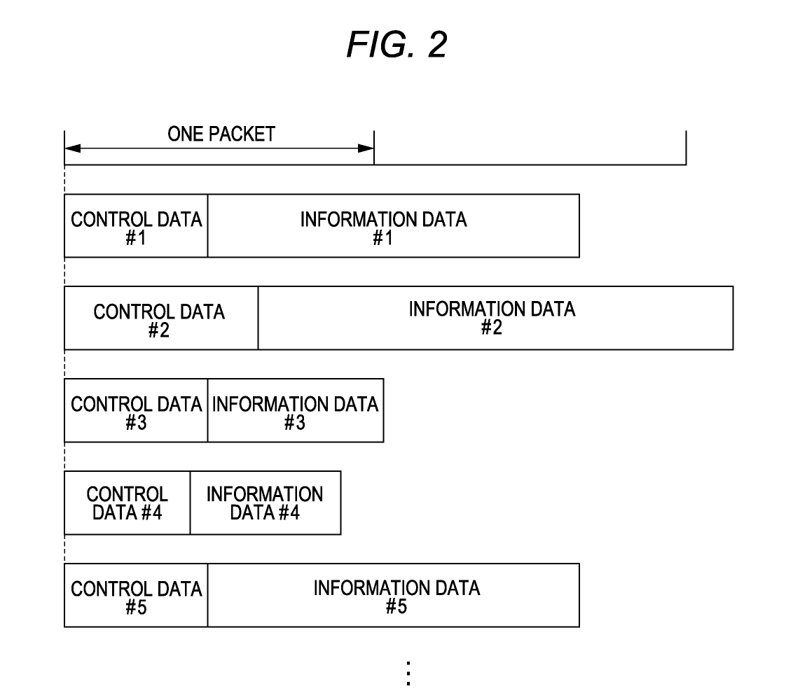

As shown in FIG. 2, the server 10 and the client 20 produce messages having different sizes, and the server 10 and the client 20 transmit the message after the messages are divided into the packets. In FIG. 2, the message including control data #1 and information data #1, for example, is transmitted while divided into two packets, and the message including control data #4 and information data #4 is transmitted in one packet. When the message is transmitted while divided into a plurality of packets, only the initially transmitted packet includes the control data. Hereinafter the packet including the control data is referred to as lead packet. In the tunneling, the lead packet including the control data is transmitted and received between the server 10 and the client 20, thereby establishing the unauthorized transmission path.

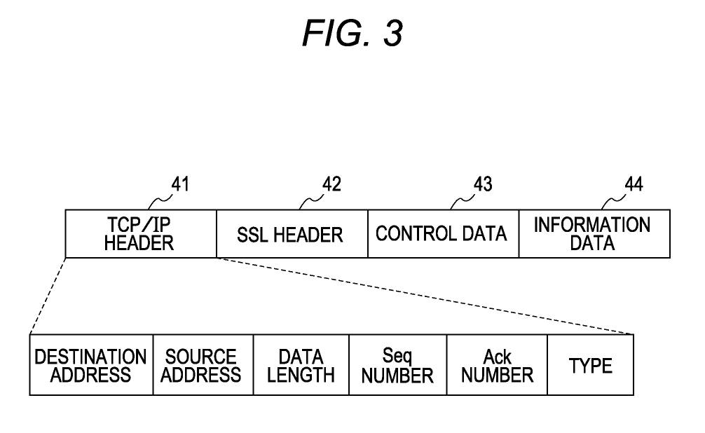

FIG. 3 illustrates an example of a packet configuration of the embodiment. Referring to FIG. 3, control data 43 and information data 44 make up the message, and an SSL (Secure Socket Layer) header 42 and a TCP/IP header 41 are added to the control data 43 and information data 44. Because the SSL header 42 is a header related to encryption, the SSL header 42 may be eliminated when the data is encrypted.

The TCP/IP header 41 is added to transmit and receive the packet through the Internet, and the TCP/IP header 41 includes fields such as a destination address, a source address, a data length, a Seq number, an Ack number, and a type. The destination address and the source address are fields in which a destination address and a source address of the packet are accommodated, respectively. At this point, the addresses of the server 10 and client 20 are stored in the destination address and source address fields. The data length is a field relating to a size of data included in the packet, and the sizes of the SSL header 42, control data 43, and information data 44 are stored in the data length.

The Seq number is a field which a numerical value indicating a total amount of data transmitted from the transmission side is accommodated within a session established between the server 10 and the client 20. Accordingly, the numerical value indicating the total amount of data transmitted as the Seq number from the server 10 within the session is accommodated in the packet transmitted from the server 10, and the numerical value indicating the total amount of data transmitted as the Seq number from the client 20 within the session is accommodated in the packet transmitted from the client 20.

On the other hand, the Ack number is a field in which a numerical value indicating a total amount of data transmitted from the reception side is accommodated in the session established between the server 10 and the client 20. Accordingly, the numerical value indicating the total amount of data transmitted as the Ack number from the client 20 within the session is accommodated in the packet transmitted from the server 10, and the numerical value indicating the total amount of data transmitted as the Ack number from the server 10 within the session is accommodated in the packet transmitted from the client 20. An initial value becomes an unusual numerical value for both the Seq number and the Ack number.

The type is a field in which a type of the field is accommodated. The types of packets such as an SYN packet for making a request to establish the session, an FIN packet for making a request to disconnect the session, and an ACK packet which is a reception confirming response of the packet are accommodated in the type field.

Referring to FIG. 1, the communication monitoring apparatus 100 obtains a packet transmitted and received between the server 10 and the client 20, and the communication monitoring apparatus 100 monitors whether or not an unauthorized message is transmitted and received in each session established between the server 10 and the client 20. At this point, the communication monitoring apparatus 100 extracts the lead packet on the basis of the Ack number and data length fields included in the TCP/IP header 41 of the packet, and the communication monitoring apparatus 100 verifies only the extracted lead packet for an unauthorized signature. The communication monitoring performed by the communication monitoring apparatus 100 is described in detail later.

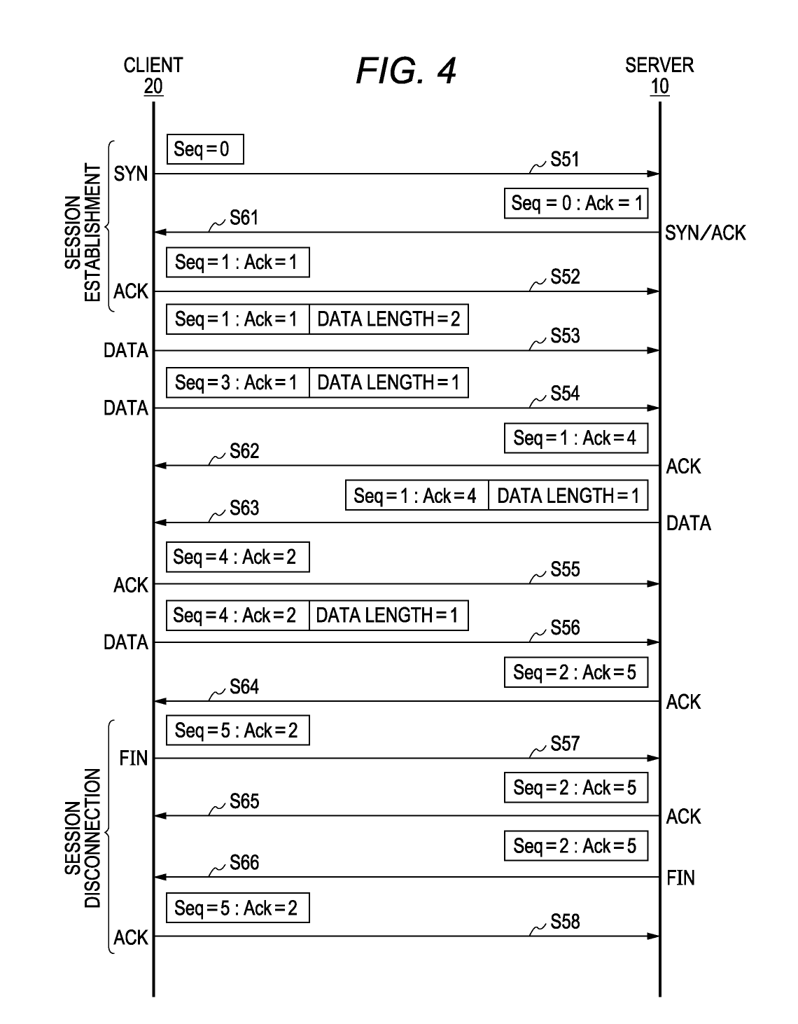

A communication procedure between the server 10 and the client 20 of the embodiment will be described with reference to FIG. 4. FIG. 4 is a sequence diagram illustrating a case in which the client 20 makes a request for establishing the session to the server 10 to transmit and receive a packet including a message.

When making the request for establishing the session with the server 10, the client 20 transmits the SYN packet to the server 10 (Step S51). Since the SYN packet does not include the message, the TCP/IP SYN packet usually includes only the header 41. Because the SYN packet is the packet initially transmitted in the session, the initial value is accommodated in the Seq number of the TCP/IP header 41, and the numerical value is not accommodated in the Ack number. Although the initial value of the Seq number is set at zero in the embodiment, the initial value of the Seq number may be a random number.

When the server 10 receives the SYN packet, the server 10 transmits the SYN/ACK packet to the client 20 for the purpose of reception confirming response of the SYN packet (Step S61). Since the SYN/ACK packet does not include the message, the SYN/ACK packet usually includes only the TCP/IP header 41. Because the SYN/ACK packet is the packet initially transmitted from the server 10 in the session, the initial value of zero is accommodated in the Seq number of the TCP/IP header 41, and the value of one which is added to the Seq number of the SYN packet is accommodated in the Ack number. Although the initial value of the Seq number is set at zero in the embodiment, the initial value of the Seq number may be a random number.

When the client 20 receives the SYN/ACK packet, the client 20 transmits the ACK packet to the server 10 as a reception confirming response of the SYN/ACK packet (Step S52). The value of one, which is equal to the Ack number of the SYN/ACK packet, is accommodated in the Seq number of the ACK packet. The value of one which is added to the Seq number of the SYN/ACK packet is accommodated in the Ack number.

After transmitting the ACK packet, the client 20 transmits a DATA packet including the message to the server 10. At this point, because the message is large, the client 20 transmits the message with the message divided into two DATA packets (Steps S53 and S54). Because the message is not transmitted and received in the session until the first DATA packet is transmitted, the Seq number and Ack number of the first DATA packet are kept at the value of one. On the other hand, when the second DATA packet is transmitted, the Seq number is increased by two to three because the message having the data length of two is transmitted by the first DATA packet.

The server 10 transmits the ACK packet, which is the reception confirming response of the two DATA packets, to the client 20 when receiving the two DATA packets (Step S62). Because the message is not transmitted from the server 10 in the session until the ACK packet is transmitted, the Seq number of the ACK packet is kept at the value of one. On the other hand, the Ack number of the ACK packet is increased by three to four because the client 20 transmits the messages having the data lengths of two and one are transmitted by the first and second DATA packets.

After transmitting the ACK packet, the server 10 transmits the DATA packet including data of a web page to the client 20 (Step S63). At this point, the message having the data length of one is transmitted as one DATA packet. The Seq number of the DATA packet is kept at the value of one and the Ack number is kept at the value of four because the server 10 does not transmit the message in the session and the amount of data transmitted from the client 20 has not changed.

The client 20 transmits the ACK packet as the reception confirming response of the DATA packet to the server 10 when receiving the DATA packet (Step S55). When the client 20 transmits the ACK packet, the client 20 has already transmitted the messages having the data lengths of two and one, and the server 10 has already transmitted the message having the data length of one. Therefore, the Seq number of the ACK packet becomes four and the Ack number becomes two.

After transmitting the ACK packet, the client 20 transmits the DATA packet to the server 10 in a similar way (Step S56). At this point, the data length of the DATA packet is set at one. The server 10 transmits the ACK packet to the client 20 when receiving the DATA packet (Step S64). The Seq number of the ACK packet becomes two and the Ack number becomes five, because the amount of data transmitted in the DATA packet from the server 10 and client 20 is increased compared to the preceding packet transmission.

Thus, the server 10 and the client 20 transmit and receive the DATA packet and ACK packet using the established session, thereby increasing the Seq number and Ack number indicating the data amount of the messages transmitted and received in the session. When the session is disconnected, the client 20 transmits an FIN packet to the server 10 (Step S57). When receiving the FIN packet, the server 10 transmits an ACK packet to the client 20 (Step S65), and the server 10 also transmits the FIN packet in the same way as the client 20 (Step S66). The client 20 transmits the ACK packet in response to the FIN packet transmitted from the server 10 (Step S58), and the client 20 disconnects the session. Because a message is not transmitted and received during the session disconnection processing, the Seq number and Ack number of each packet are not changed.

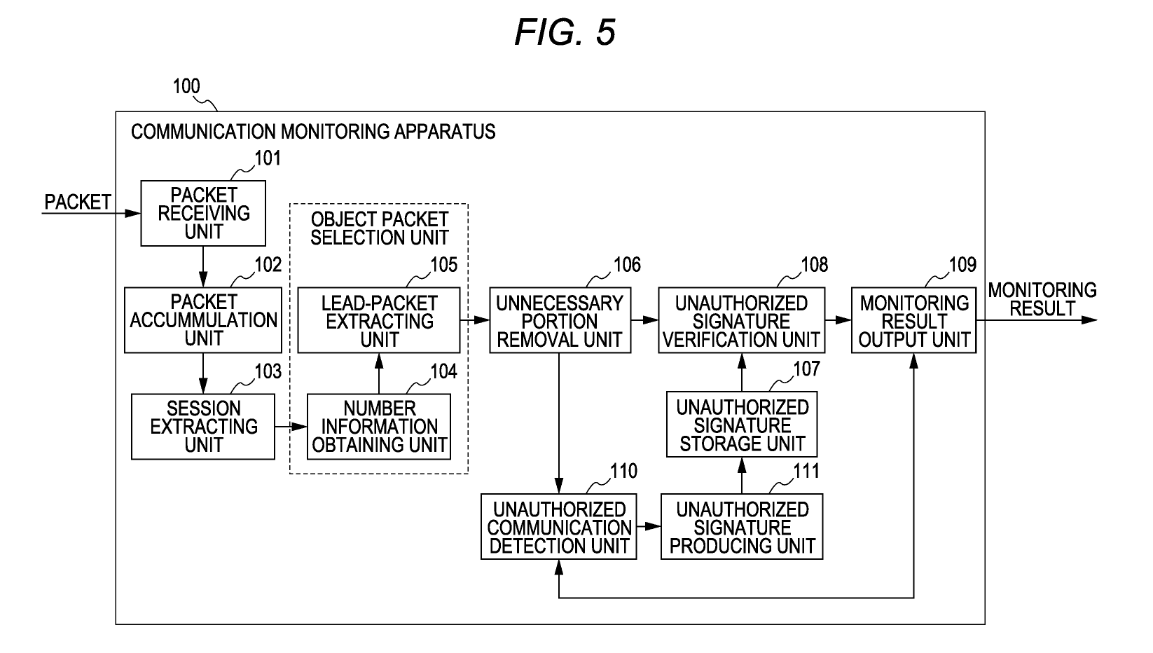

The communication monitoring apparatus 100 of the embodiment obtains the packets transmitted and received in the session between the server 10 and the client 20, and the communication monitoring apparatus 100 determines whether or not the session is related to the unauthorized communication such as the tunneling. FIG. 5 is a block diagram illustrating a configuration of the main components of the communication monitoring apparatus 100 of the embodiment. Referring to FIG. 5, the communication monitoring apparatus 100 includes a packet receiving unit 101, a packet accumulation unit 102, a session extracting unit 103, a number information obtaining unit 104, a lead-packet extracting unit 105, an unnecessary portion removal unit 106, an unauthorized signature storage unit 107, an unauthorized signature verification unit 108, a monitoring result output unit 109, an unauthorized communication detection unit 110, and an unauthorized signature producing unit 111.

The packet receiving unit 101 receives all the packets transmitted and received between the server 10 and the client 20. The packet accumulation unit 102 accumulates the packets received by the packet receiving unit 101. The packet accumulation unit 102 may transmit the packet to the server 10 or client 20 specified by the destination address when the unauthorized communication is not detected in the session by the processing described below. The packet accumulation unit 102 accumulates a duplicate of the packet received by the packet receiving unit 101, and the packet accumulation unit 102 may transmit the original packet to the server 10 or client 20.

The session extracting unit 103 extracts a packet group corresponding to one session from the packets accumulated by the packet accumulation unit 102. The session extracting unit 103 searches and extracts the SYN packet transmitted and received in establishing the session and the FIN packet transmitted and received in disconnecting the session from the packets accumulated by the packet accumulation unit 102, and the session extracting unit 103 extracts all the packets transmitted and received between the same server 10 and client 20 between the SYN packet and the FIN packet. The session extracting unit 103 may search for an RST packet transmitted and received when forcedly ending the session or look for a timeout of the session while extracting a session.

The number information obtaining unit 104 obtains number information including the Seq number, Ack number, and data length from the TCP/IP header of each packet of one session extracted by the session extracting unit 103.

The lead-packet extracting unit 105 extracts the lead packet including message control data on the basis of the Seq number, Ack number, and data length obtained by the number information obtaining unit 104. The lead-packet extracting unit 105 determines that the packet having the data length of zero obtained by the number information obtaining unit 104 is not the lead packet, because the packet having the data length of zero does not include the message such as the SYN packet and the ACK packet. Then, the lead-packet extracting unit 105 arranges the packets, except for the packet having the data length of zero, in the order of the Seq number. Furthermore, the lead-packet extracting unit 105 refers to the Ack numbers of the packets arranged chronologically, and the lead-packet extracting unit 105 extracts the packet whose Ack number is increased as the lead packet from the immediately preceding packet.

The number information obtaining unit 104 and the lead-packet extracting unit 105 act as an object packet selection unit which selects an object packet used in performing the verification between the object packet and the unauthorized signature. Thus, the load of the verification processing can be reduced by narrowing the number of object packets from all the packets in the session.

The unnecessary portion removal unit 106 removes portion from the packet in the session unnecessary to detect the unauthorized communication such as the tunneling. The unnecessary portion removal unit 106 removes the TCP/IP header added to the packet and the SSL header relating to the message encryption, and the unnecessary portion removal unit 106 obtains only a message portion. The unnecessary portion removal unit 106 supplies the message portion of the lead packet extracted by the lead-packet extracting unit 105 to the unauthorized signature verification unit 108. The unnecessary portion removal unit 106 supplies the message portions of all the packets to the unauthorized communication detection unit 110 when the unauthorized communication detection unit 110 makes a request.

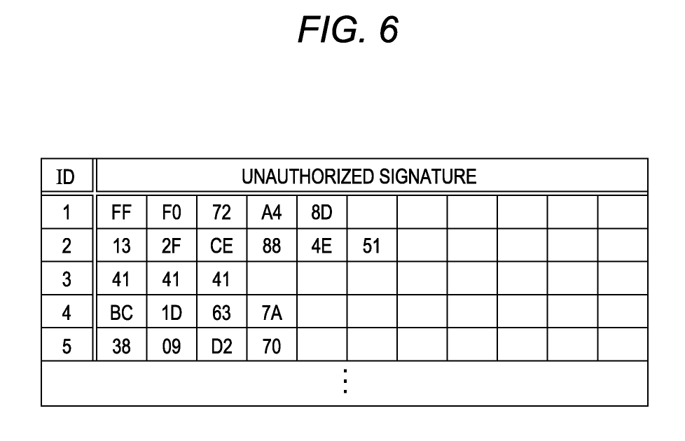

A data pattern frequently included in the packet transmitted and received during the unauthorized communication such as the tunneling is stored as an unauthorized signature in the unauthorized signature storage unit 107. As shown in FIG. 6, the plurality of unauthorized signatures each of which includes a data pattern having several bytes are stored in the unauthorized signature storage unit 107. Although not shown in FIG. 6, a position at which each unauthorized signature is placed in the message portion of the packet is stored in the unauthorized signature storage unit 107 along with the data pattern. That is, in which byte each data pattern shown in FIG. 6 is placed from the first byte of the message portion is stored in the unauthorized signature storage unit 107.

The unauthorized signature verification unit 108 performs the verification between the message portion of the lead packet whose unnecessary portion is removed by the unnecessary portion removal unit 106 and the unauthorized signature stored in the unauthorized signature storage unit 107. That is, the unauthorized signature verification unit 108 determines whether or not the message portion of the lead packet includes the data pattern that matches the unauthorized signature. When the message portion of the lead packet includes the data pattern that matches the unauthorized signature, the unauthorized signature verification unit 108 notifies the monitoring result output unit 109 that the currently extracted session is the unauthorized communication. When the message portion of the lead packet does not include the data pattern that matches the unauthorized signature, the unauthorized signature verification unit 108 notifies the monitoring result output unit 109 that the detection of the unauthorized communication is required without utilizing the unauthorized signature.

When notified by the unauthorized signature verification unit 108 that the currently extracted session is the unauthorized communication, the monitoring result output unit 109 supplies a monitoring result that indicates that the currently extracted session is the unauthorized communication. When notified by the unauthorized signature verification unit 108 that the detection of the unauthorized communication is required without utilizing the unauthorized signature, the monitoring result output unit 109 provides an instruction for detecting the unauthorized communication to the unauthorized communication detection unit 110.

When receiving the instruction from the monitoring result output unit 109, the unauthorized communication detection unit 110 obtains the message portions of all the packets whose unnecessary portions are removed by the unnecessary portion removal unit 106, and the unauthorized communication detection unit 110 determines whether or not the message portion includes the unauthorized communication. The unauthorized communication detection unit 110 determines whether or not the same data pattern repeatedly appears in the message portion in the session, and the unauthorized communication detection unit 110 determines that the session is the unauthorized communication when the same data pattern repeatedly appears. This means that the unauthorized communication is detected according to an appearance frequency of the same data pattern, because the same data pattern is frequently included in the message portion, particularly in the control data in order to establish the unauthorized transmission path in the unauthorized communication such as the tunneling.

The unauthorized communication detection unit 110 actually may access the address specified in the message portion determined as the unauthorized communication, and the unauthorized communication detection unit 110 may determine whether or not a word characterizing the unauthorized communication is included in the web page obtained from the specified address, thereby more securely detecting the unauthorized communication. When determining that the session is the unauthorized communication, the unauthorized communication detection unit 110 causes the monitoring result output unit 109 to supply the determination result indicating that the session is the unauthorized communication.

When the unauthorized communication detection unit 110 determines that the session is the unauthorized communication, the unauthorized signature producing unit 111 produces the unauthorized signature from the same data pattern which repeatedly appears in the message portion. That is, because the unauthorized communication detection unit 110 determines that the session in which the same data pattern repeatedly appears is the unauthorized communication, the unauthorized signature producing unit 111 considers the series of data patterns repeatedly appearing in the session as the unauthorized signature which becomes the feature of the unauthorized communication. The unauthorized signature producing unit 111 stores the produced unauthorized signature in the unauthorized signature storage unit 107. Accordingly, when the unauthorized communication detection unit 110 detects the unauthorized communication, the unauthorized signature storage unit 107 learns the unauthorized signature newly produced by the unauthorized signature producing unit 111.

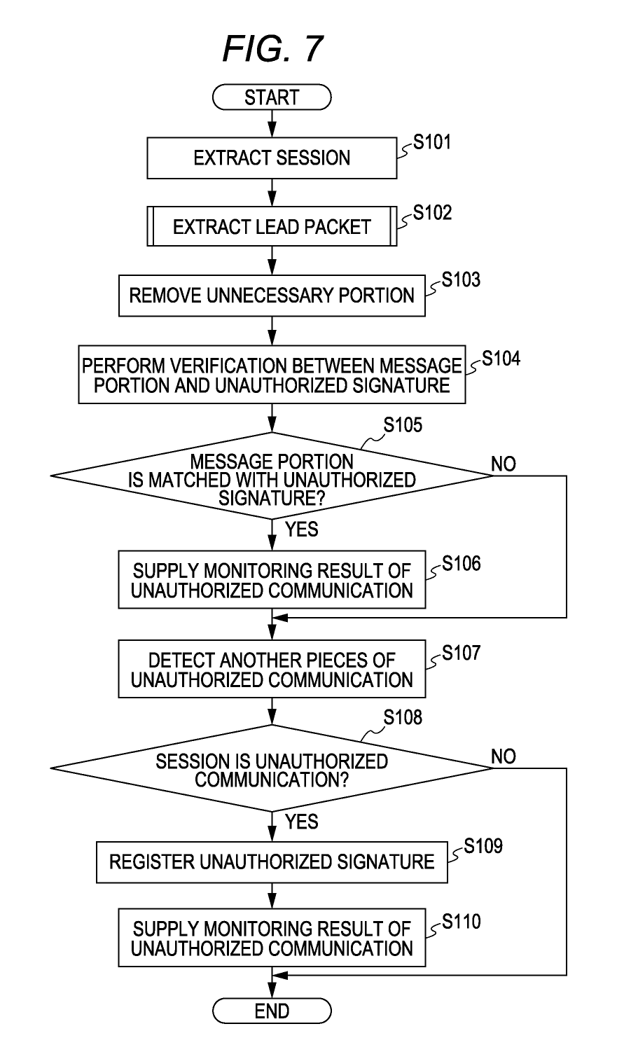

An operation of the communication monitoring apparatus 100 having the above-described configuration will be described with reference to a flowchart of FIG. 7.

The packet receiving unit 101 of the communication monitoring apparatus 100 receives the packet transmitted and received between the server 10 and the client 20, and the packet accumulation unit 102 accumulates the packets. The session extracting unit 103 extracts the packet group corresponding to one session from the accumulated packets (Step S101). That is, the session extracting unit 103 detects the SYN packet transmitted and received in establishing the session and the FIN packet transmitted and received in disconnecting the session, and the packet group transmitted and received from the transmission and reception of the SYN packet and the transmission and reception of the FIN packet is extracted as the packet of one session. As described above, in extracting the session, the session extracting unit 103 may also search for the RST packet or detect the timeout of the session.

The number information obtaining unit 104 obtains the number information including the Seq number, Ack number, and data length from the TCP/IP header of the packet in the session. The number information obtaining unit 104 notifies the lead-packet extracting unit 105 of the obtained number information, and the lead-packet extracting unit 105 extracts the lead packet including the message control data (Step S102). The lead packet extraction performed by the lead-packet extracting unit 105 is described later.

After the lead packet is extracted in the session, the unnecessary portion removal unit 106 removes the unnecessary portions except for the message portions from all the packets in the session (Step S103). The TCP/IP header 41 and the SSL header 42 are removed in the packet configuration shown in FIG. 3. Thus, in the embodiment, because not only the TCP/IP header but also the unnecessary portion such as the SSL header except for the message portion are removed from the packet, mistakenly detecting that the session is the unauthorized communication can be prevented if the data pattern matched with the unauthorized signature is included in the SSL header.

When the message portions are obtained from all the packets in the session, the lead-packet message portion is fed into the unauthorized signature verification unit 108, and the unauthorized signature verification unit 108 performs the verification between the lead-packet message portion and the unauthorized signature already stored in the unauthorized signature storage unit 107 (Step S104). At this point, in the embodiment, the lead-packet extracting unit 105 extracts the lead packet, and the verification is performed between only the message portion of the extracted lead packet and the unauthorized signature. Therefore, it is not necessary to perform the verification for all the packets in the session, so that the load of the verification processing can be reduced in the unauthorized signature verification unit 108. The lead packet particularly includes the control data of the message. Therefore, when the verification is performed only on the lead packet and the unauthorized signature, all the pieces of control information for establishing the unauthorized transmission path can be detected, without omitting anything of significance and the unauthorized communication such as the tunneling may be detected more reliably.

The unauthorized signature verification unit 108 determines whether or not the lead-packet message portion partially includes the unauthorized signature (Step S105). When a part of the lead-packet message portion includes the unauthorized signature (Yes in Step S105), the monitoring result output unit 109 issues the monitoring result indicating that the currently extracted session is the unauthorized communication (Step S106). When the lead-packet message portion is verified against the unauthorized signature, the packet in the session accumulated in the packet accumulation unit 102 may be cancelled or transmitted to the server 10 or client 20, which is the destination address.

On the other hand, when a part of the lead-packet message portion does not include the unauthorized signature (No in Step S105), the monitoring result output unit 109 instructs the unauthorized communication detection unit 110 to detect the unauthorized communication without utilizing the unauthorized signature. In the embodiment, in order to learn a new unauthorized signature, the unauthorized communication detection in which the unauthorized signature is not utilized is attempted even for the session in which the determination of the unauthorized communication is made through the verification with the unauthorized signature by the unauthorized signature verification unit 108.

That is, the unauthorized communication detection unit 110 obtains the message portions of all the packets in the session from the unnecessary portion removal unit 106, and the unauthorized communication detection unit 110 determines whether or not the same data pattern repeatedly appears in the control data of each message portion, thereby detecting the unauthorized communication (Step S107). As described above, in the session corresponding to the unauthorized communication such as the tunneling, the same data pattern is frequently included in the control data of the message portion in order to establish the unauthorized transmission path. Therefore, the unauthorized communication detection unit 110 detects the repetition of the data pattern to determine whether or not the session is the unauthorized communication (Step S108).

Alternatively, when the repetition of the same data pattern is detected from the message portion, the unauthorized communication detection unit 110 may actually access the address specified by the message portion, and the unauthorized communication detection unit 110 may confirm whether or not words characterizing the unauthorized communication are in the web page obtained from the specified address, thereby more reliably detecting the unauthorized communication.

When the unauthorized communication detection unit 110 determines that the session is the unauthorized communication (Yes in Step S108), the unauthorized signature producing unit 111 produces the new unauthorized signature from the same data pattern which repeatedly appears in the control data in the session, and the newly produced unauthorized signature is registered in the unauthorized signature storage unit 107 (Step S109). Similar to the case in which the unauthorized signature verification unit 108 determines that the session is the unauthorized communication, the monitoring result output unit 109 outputs a monitoring result indicating that the currently extracted session is the unauthorized communication (Step S110). When the currently extracted session is the unauthorized communication, the packet in the session accumulated in the packet accumulation unit 102 is cancelled or transmitted to the server 10 or client 20 which is the destination address, and the processing is completed.

On the other hand, when the unauthorized communication detection unit 110 determines that the session is not the unauthorized communication (No in Step S108), the packet in the session accumulated in the packet accumulation unit 102 is transmitted to the server 10 or client 20 which is the destination address, and the processing is completed. When the original packet is already transmitted to the server 10 or client 20 while the duplicate of the packet is accumulated in the packet accumulation unit 102, the duplicate of the packet accumulated in the packet accumulation unit 102 may be cancelled.

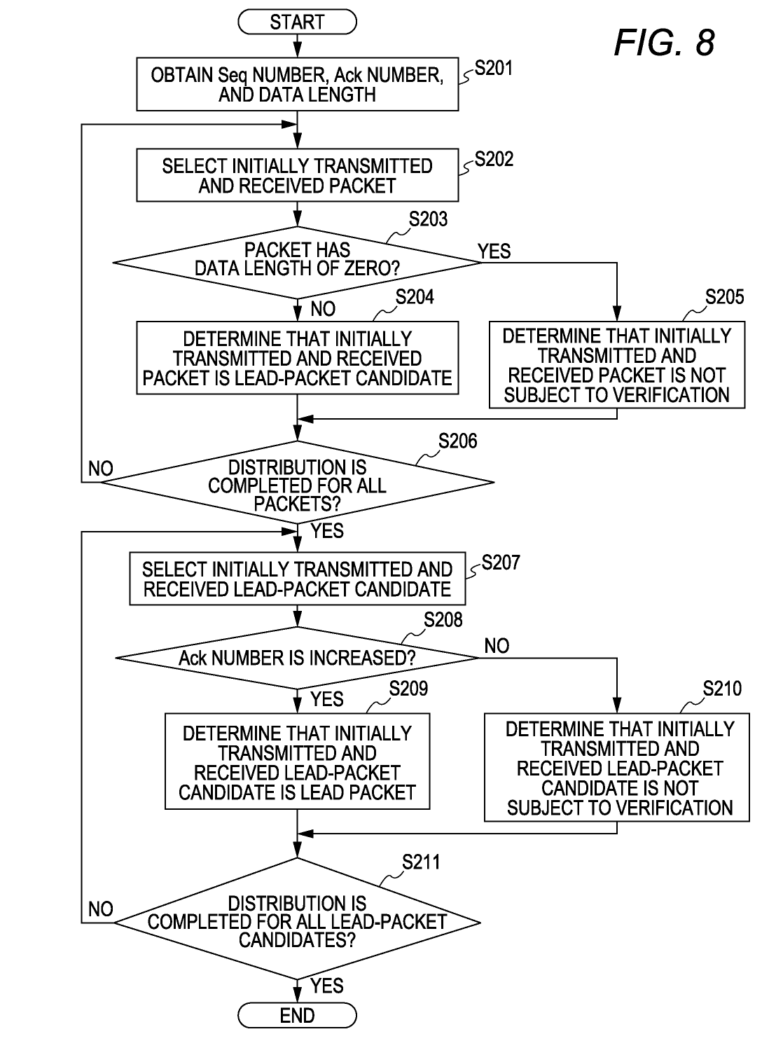

The lead-packet extracting processing of the embodiment will be described with reference to a flowchart of FIG. 8.

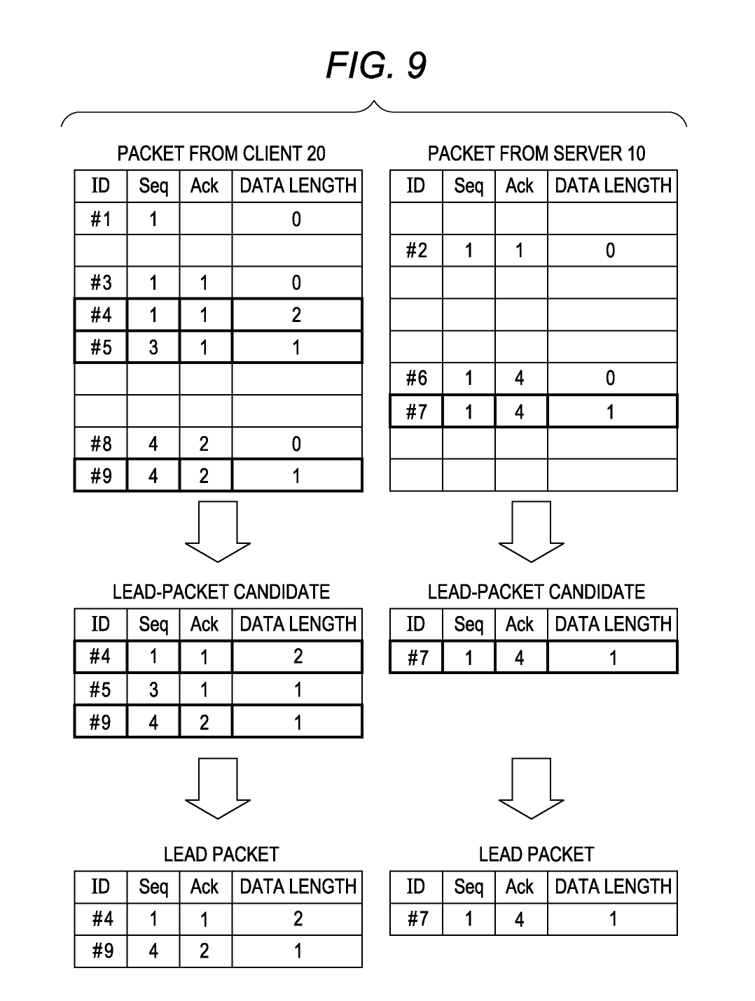

In the embodiment, the session extracting unit 103 extracts the packet of one session from the packets accumulated by the packet accumulation unit 102. The number information obtaining unit 104 obtains the Seq number, Ack number, and data length stored in the TCP/IP header of each packet (Step S201). As shown in FIG. 9, it is assumed that packets #1, #3, #4, #5, #8, and #9 transmitted from the client 20 and the packets #2, #6, and #7 transmitted from the server 10 are extracted as the packets corresponding to one session, and it is also assumed that each packet has the Seq number, Ack number, and data length shown in FIG. 9.

When the number information obtaining unit 104 obtains the Seq number, Ack number, and data length of each packet, the lead packet extracting unit 105 selects the packet which is initially transmitted and received in the session (Step S202). At this point, the packet #1 transmitted from the client 20 is selected as the initially transmitted and received packet. The lead packet extracting unit 105 determines whether or not the initially transmitted and received packet has the data length of zero (Step S203). When the initially transmitted and received packet has the data length of zero (Yes in Step S203), because the initially transmitted and received packet is the packet which does not include the message such as the SYN packet and the ACK packet, it is determined that the initially transmitted and received packet is not subject to verification for the unauthorized signature (Step S205). At this point, because the packet #1 which is the initially transmitted and received packet has the data length of zero, the packet #1 is not subject to verification.

On the other hand, when the initially transmitted and received packet does not have the data length of zero (No in Step S203), because the initially transmitted and received packet is the packet including the message, it is determined that the initially transmitted and received packet is a lead-packet candidate including the control data (Step S204). When the determination whether the initially transmitted and received packet is the lead-packet candidate or not subject to verification is made, the lead-packet extracting unit 105 determines whether all the packets in the session are distributed to the lead-packet candidate or are not subject to verification (Step S206). When the distribution is completed for all the packets (Yes in Step S206), the flow goes to next processing. In this case, because the packet #1 is only distributed to the not subject to verification packets, the distribution is not completed for all the packets (No in Step S206), the packet #2 is selected from the remaining packets in the session as the initially transmitted and received packet (Step S202), and the distribution similar to the packet #1 is performed.

The packets #4, #5, and #9 transmitted from the client 20 and the packet #7 transmitted from the server 10, shown by bold frames in FIG. 9, become the lead-packet candidates by repeating the distribution as shown in FIG. 9. In the packets #4, #5, #7, and #9 do not have the data length of zero.

When the lead-packet extracting unit 105 extracts the lead packet candidate, the initially transmitted and received lead-packet candidate is selected in the lead-packet candidates (Step S207). At this point, the packet #4 transmitted from the client 20 is selected. It is determined whether or not the Ack number of the selected lead-packet candidate selected by the lead-packet extracting unit 105 has increased from the Ack number of the immediately preceding lead-packet candidate (Step S208). In the determination in Step S208, the Ack number of the selected lead-packet candidate is compared to the Ack number of the immediately preceding lead-packet candidate transmitted from the client 20 when the selected lead-packet candidate is the packet transmitted from the client 20, and the Ack number of the selected lead-packet candidate is compared to the Ack number of the immediately preceding lead-packet candidate transmitted from the server 10 when the selected lead-packet candidate is the packet transmitted from the server 10. If the immediately preceding lead-packet candidate does not exist, it is determined that the Ack number is increased.

When, according to the result, the Ack number is increased (Yes in Step S208), since the selected lead-packet candidate is the packet including the message which is initially transmitted after the session is started or the packet including the message is received from the destination of the packet, the packet includes the control data, thereby making the determination that the selected lead-packet candidate is the lead packet (Step S209). At this point, the determination that the packet #4 is the lead packet is made because the selected packet #4 is the packet including the message which is initially transmitted after the session is started.

On the other hand, when the Ack number is not increased (No in Step S208), because the selected lead-packet candidate is the packet including only the message information in which the data is divided, it is determined that the selected lead packet candidate not subject to the verification for the unauthorized signature (Step S210). When the determination whether or not the selected lead-packet candidate is the lead packet of the not subject to verification packet is made, the lead-packet extracting unit 105 determines whether or not all the lead-packet candidates in the session are distributed to the lead packet or not subject to verification packet (Step S211). When the distribution is completed for all the packets (Yes in Step S211), the extraction of the lead packet is completed. At this point, because only the packet #4 is distributed to the lead packet, the distribution is not completed for all the packets (No in Step S211), the initially transmitted and received packet #5 is selected from the remaining lead-packet candidates in the session (Step S207), and the distribution similar to that of the packet #4 is performed for the packet #5.

The packets #4 and #9 transmitted from the client 20 and the packet #7 transmitted from the server 10, shown in bold frames in FIG. 9, become the lead packets by repeating the distribution as shown in FIG. 9. Because the Ack number of the packet #5 has the Ack number of one which is equal to the Ack number of the packet #4 even though the packet #5 has the data length of one, it is found that the packet including the message is not received from the packet transmission destination between the transmission of the packet #4 and the transmission of the packet #5. Accordingly, the packet #4 and the packet #5 are the packets which are transmitted while the series of messages is divided, and it is determined that the packet #5 is not the lead packet.

Thus, in the embodiment, the lead packet including the message control data is extracted from the Seq number, Ack number, and data length stored in the TCP/IP header of the packet, and the verification is performed between only the extracted lead packet and the unauthorized signature.

Therefore, the verification between all the packets and the unauthorized signature can be eliminated to reduce the processing load. Because the verification is typically performed between the message control data used in the unauthorized communication such as the tunneling and the unauthorized signature, the accuracy of unauthorized communication detection is maintained.

In the embodiment, when the determination that the session is not the unauthorized communication is made by the verification with the unauthorized signature, the unauthorized communication is detected to learn the new unauthorized signature by another method in which the unauthorized signature is not utilized. However, it is not always necessary to learn the unauthorized signature. When all the unauthorized signatures are previously stored in the unauthorized signature storage unit 107, the verification can be performed between the unauthorized signatures and the lead packet, which allows the unauthorized communication to be more reliably detected. In such cases, it is only necessary that the unnecessary portion removal unit 106 remove the unnecessary portion such as the TCP/IP header for the lead packet, so that the processing load can further be reduced.

In the embodiment, the communication monitoring apparatus 100 extracts the lead packet and performs the verification between the lead packet and the unauthorized signature. Alternatively, the processing may be described as a program which can be read by a computer, and the computer can execute the program to implement the embodiment. The program in which processing contents are described can be recorded in a computer-readable recording medium. Examples of the computer-readable recording medium include a magnetic recording device, an optical disk, a magneto-optical recording medium, and a semiconductor memory. Examples of the magnetic recording device include a Hard Disk Drive (HDD), a Flexible Disk (FD) and a magnetic tape. Examples of the optical disk include DVD (Digital Versatile Disc), DVD-RAM, CD-ROM (Compact Disc Read Only Memory), and CD-R (Recordable)/RW (Re Writable). An example of the magneto-optical recording medium includes MO (Magneto-Optical disc).

For example, a portable recording medium such as DVD and CD-ROM in which the program is recorded may be sold when the program is circulated. Alternatively, the program is stored in a storage device of a server computer and the program can be transferred from the server computer to other computers through the network.

The computer which executes the program stores the program recorded in the portable recording medium or the program transferred from the server computer in the storage device thereof. Then, the computer reads the program from the storage device to perform the processing according to the program. Alternatively, the computer may directly read the program from the portable recording medium to perform the processing according to the program. Alternatively, the computer may perform the processing according to the program every time the program is transferred from the server computer.

What is claimed is:

1. A communication monitoring apparatus comprising:
a session extracting unit which extracts a packet transmitted and received in a session established between a pair of a transmitting device and a receiving device from a plurality of packets transmitted and received by a specific protocol;
a lead-packet extracting unit which extracts a lead packet including control information on communication between the transmitting device and the receiving device from the packet in the session extracted by the session extracting unit;
a storage unit in which an unauthorized signature is stored, the unauthorized signature including a data pattern which distinctively appears in control information on unauthorized communication;
a verification unit which performs verification between the lead packet extracted by the lead-packet extracting unit and the unauthorized signature stored in the storage unit; and
an output unit which supplies a monitoring result indicating that the session extracted by the session extracting unit is the unauthorized communication when the lead packet includes a portion matched with the unauthorized signature as a result of the verification performed by the verification unit.

2. The communication monitoring apparatus according to claim 1, wherein the lead-packet extracting unit extracts the lead packet from a candidate packet including a message portion in the packets in the session extracted by the session extracting unit, the message portion accommodating control information therein in addition to a header portion.

3. The communication monitoring apparatus according to claim 2, wherein the lead-packet extracting unit extracts a candidate packet as the lead packet, the candidate packet being transmitted from one of the transmitting device and the receiving device, the candidate packet being initially transmitted after one of the transmitting device and the receiving device receives a candidate packet from the other of the transmitting device and the receiving device.

4. The communication monitoring apparatus according to claim 2, wherein the lead-packet extracting unit extracts a candidate packet as the lead packet, the candidate packet being initially transmitted from one of the transmitting device and the receiving device after the session is established between the transmitting device and the receiving device.

5. The communication monitoring apparatus according to claim 2, wherein the lead-packet extracting unit extracts the lead packet based on the header portion of the candidate packet transmitted from one of the transmitting device and the receiving device, the header portion indicating an amount of data already transmitted from the other of the transmitting device and the receiving device.

6. The communication monitoring apparatus according to claim 1, wherein the verification unit includes a removal unit which removes a header portion from the lead packet extracted by the lead-packet extracting unit, and the verification unit performs verification between a message portion and the unauthorized signature, the message portion being obtained in such a manner that the removal unit removes the header portion.

7. The communication monitoring apparatus according to claim 1, further comprising:
a determination unit which determines whether or not the session extracted by the session extracting unit is the unauthorized communication irrespective of the verification result of the verification unit; and
a producing unit which produces an unauthorized signature from a data pattern which repeatedly appears in the packet of the session when the determination unit determines that the session is the unauthorized communication,
wherein the unauthorized signature produced by the producing unit is stored in the storage unit.

8. A computer-readable recording medium in which a communication monitoring program is recorded, the communication monitoring program being executed by a computer including a memory in which an unauthorized signature having a data pattern is stored, the data pattern distinctively appearing in control information in unauthorized communication,
wherein the communication monitoring program causes the computer to execute:
a session extracting step of extracting a packet transmitted and received in a session established between a pair of a transmitting device and a receiving device from a plurality of packets transmitted and received by a specific protocol;
a lead-packet extracting step of extracting a lead packet including control information on communication between the transmitting device and the receiving device from the packet in the session extracted in the session extracting step;
a verification step of performing verification between the lead packet extracted by the lead-packet extracting step and the unauthorized signature stored in the memory; and
an output step of supplying a monitoring result indicating that the session extracted by the session extracting step is the unauthorized communication when the lead packet includes a portion matched with the unauthorized signature as a result of the verification performed in the verification step.

9. The computer-readable recording medium in which the communication monitoring program is recorded according to claim 8, wherein, in the lead-packet extracting step, the lead packet is extracted from a candidate packet including a message portion among the packets in the session extracted by the session extracting step, the message portion accommodating control information therein in addition to a header portion.

10. The computer-readable recording medium in which the communication monitoring program is recorded according to claim 9, wherein, in the lead packet extracting step, a candidate packet is extracted as the lead packet, the candidate packet being transmitted from one of the transmitting device and the receiving device, the candidate packet being initially transmitted after one of the transmitting device and the receiving device receives a candidate packet from the other of the transmitting device and the receiving device.

11. The computer-readable recording medium in which the communication monitoring program is recorded according to claim 9, wherein, in the lead-packet extracting step, a candidate packet is extracted as the lead packet, the candidate packet being initially transmitted from one of the transmitting device and the receiving device after the session is established between the transmitting device and the receiving device.

12. The computer-readable recording medium in which the communication monitoring program is recorded according to claim 9, wherein, in the lead-packet extracting step, the lead packet is extracted based on the header portion of the candidate packet transmitted from one of the transmitting device and the receiving device, the header portion indicating an amount of data already transmitted from the other of the transmitting device and the receiving device.

13. The computer-readable recording medium in which the communication monitoring program is recorded according to claim 8, wherein the verification step includes a removal step of removing a header portion from the lead packet extracted in the lead-packet extracting step, and
in the verification step, verification is performed between a message portion and the unauthorized signature, the message portion being obtained by removing the header portion in the removal step.

14. The computer-readable recording medium in which the communication monitoring program is recorded according to claim 8, wherein the communication monitoring program causes the computer to further execute:
a determination step of determining whether or not the session extracted in the session extracting step is the unauthorized communication irrespective of the verification result in the verification step;
a producing step of producing an unauthorized signature from a data pattern which repeatedly appears in the packet of the session when the determination that the session is the unauthorized communication is made in the determination step; and
a registration step of registering the unauthorized signature produced in the producing step in the memory.

15. A communication monitoring method in a communication monitoring apparatus including a storage unit in which an unauthorized signature having a data pattern is stored, the data pattern distinctively appearing in control information on unauthorized communication,
the communication monitoring method comprising:
a session extracting step of extracting a packet transmitted and received in a session established between a pair of a transmitting device and a receiving device from a plurality of packets transmitted and received by a specific protocol;
a lead-packet extracting step of extracting a lead packet including control information on communication between the transmitting device and the receiving device from the packet in the session extracted in the session extracting step;
a verification step of performing verification between the lead packet extracted by the lead-packet extracting step and the unauthorized signature stored in the storage unit; and
an output step of supplying a monitoring result indicating that the session extracted by the session extracting step is the unauthorized communication when the lead packet includes a portion matched with the unauthorized signature as a result of the verification performed in the verification step.

16. The communication monitoring method according to claim 15, wherein, in the lead-packet extracting step, the lead packet is extracted from a candidate packet including a message portion in the packets in the session extracted by the session extracting step, the message portion accommodating control information therein in addition to a header portion.

17. The communication monitoring method according to claim 16, wherein, in the lead packet extracting step, a candidate packet is extracted as the lead packet, the candidate packet being transmitted from one of the transmitting device and the receiving device, the candidate packet being initially transmitted after one of the transmitting device and the receiving device receives a candidate packet from the other of the transmitting device and the receiving device.

18. The communication monitoring method according to claim 16, wherein, in the lead-packet extracting step, a candidate packet is extracted as the lead packet, the candidate packet being initially transmitted from one of the transmitting device and the receiving device after the session is established between the transmitting device and the receiving device.

19. The communication monitoring method according to claim 16, wherein, in the lead-packet extracting step, the lead packet is extracted based on the header portion of the candidate packet transmitted from one of the transmitting device and the receiving device, the header portion indicating an amount of data already transmitted from the other of the transmitting device and the receiving device.

20. The communication monitoring method according to claim 15, wherein the verification step includes a removal step of removing a header portion from the lead packet extracted in the lead-packet extracting step, and
in the verification step, verification is performed between a message portion and the unauthorized signature, the message portion being obtained by removing the header portion in the removal step.
